(19) United States
(12) Patent Application Publication
(10) Pub. No.: US 2014/0313431 A1
(43) Pub. Date: Oct. 23, 2014

(54) TOUCH COLOR FILTER AND MANUFACTURING METHOD THEREOF AND TOUCH DISPLAY PANEL

(71) Applicant: Chunghwa Picture Tubes, Ltd., Taoyuan (TW)

(72) Inventors: Chiu-Ping Chang, Taoyuan County (TW); Chi-Liang Kuo, Taoyuan County (TW); Tsung-Wei Hsu, Taoyuan County (TW)

(21) Appl. No.: 13/941,545

(22) Filed: Jul. 15, 2013

(30) Foreign Application Priority Data
Apr. 22, 2013 (TW) 102114196

(51) Int. Cl. G06F 1/16

(52) U.S. Cl. CPC G06F 1/169
USPC 349/12; 427/58

(57) ABSTRACT

A touch color filter includes a substrate, a touch sensing layer, a black matrix layer, and a color filter layer. The touch sensing layer is located on the substrate. The black matrix layer is located on the substrate. A boundary of the touch sensing layer is located within a boundary of the black matrix layer. The color filter layer is located on the substrate. The touch sensing layer and the black matrix layer are located between the substrate and the color filter layer, and the color filter layer covers the touch sensing layer and the black matrix layer.

### CROSS-REFERENCE TO RELATED APPLICATION

This application claims the priority benefit of Taiwan application serial no. 102114196, filed on Apr. 22, 2013. The entirety of the above-mentioned patent application is hereby incorporated by reference herein and made a part of this specification.

### BACKGROUND OF THE INVENTION

1. Field of the Invention

The invention relates to a touch color filter, a manufacturing method thereof, and a touch display panel.

2. Description of Related Art

According to the way to arrange a touch panel and a display panel, the touch panel may be substantially categorized into an added-on type touch panel, an on-cell type touch panel, and an in-cell type touch panel. In the added-on type touch panel, touch components are often formed on a substrate to form a touch panel, and the touch panel is then adhered to an outer surface of a display panel. In the on-cell type touch panel, touch components are integrated onto a display panel. In the in-cell type touch panel, touch components are integrated into a display panel. Compared to the added-on type touch panel, the on-cell type touch panel and the in-cell type touch panel are conducive to the miniaturization of the display.

In the on-cell type touch panel, for instance, transparent sensing patterns that serve as the touch components are frequently formed on the outside of the display panel; therefore, during the operation of the on-cell type touch panel, issues of visibility of transparent sensing patterns, reflection caused by metal bridge, and color shift caused by the transparent sensing patterns often occur. By contrast, in the in-cell type touch panel, for instance, when the touch components are formed on an active device array substrate, a number of photomasks are required, thus enhancing the complexity of the entire manufacturing process. Moreover, noise interference is apt to occur between active devices and touch components, which further reduces the sensitivity of the touch panel.

### SUMMARY OF THE INVENTION

The invention is directed to a touch color filter that has favorable view quality and can be formed with low costs.

The invention is further directed to a simple manufacturing method of a touch color filter.

The invention is further directed to a touch display panel that has favorable view quality and can be formed with low costs.

In an embodiment of the invention, a touch color filter that includes a substrate, a touch sensing layer, a black matrix layer, and a color filter layer is provided. The touch sensing layer is located on the substrate. The black matrix layer is located on the substrate. A boundary of the touch sensing layer is located within a boundary of the black matrix layer. The color filter layer is located on the substrate. The touch sensing layer and the black matrix layer are located between the substrate and the color filter layer, and the color filter layer covers the touch sensing layer and the black matrix layer.

In an embodiment of the invention, a touch display panel that includes an active device array substrate, a light modulation layer, and a touch color filter is provided. The touch color filter includes a substrate, a touch sensing layer, a black matrix layer, and a color filter layer. The touch sensing layer is located on the substrate. The black matrix layer is located on the substrate. A boundary of the touch sensing layer is located within a boundary of the black matrix layer. The color filter layer is located on the substrate. The touch sensing layer and the black matrix layer are located between the substrate and the color filter layer, and the color filter layer covers the touch sensing layer and the black matrix layer. The active device array substrate is arranged opposite to the touch color filter. The light modulation layer is located between the active device array substrate and the touch color filter, and the touch sensing layer is located between the substrate and the light modulation layer.

In an embodiment of the invention, a manufacturing method of a touch color filter includes the following steps: providing a substrate; forming a touch sensing layer on the substrate; forming a black matrix layer on the substrate, wherein the touch sensing layer and the black matrix layer are overlapped, and a boundary of the touch sensing layer is located within a boundary of the black matrix layer; and forming a color filter layer on the substrate, wherein the touch sensing layer and the black matrix layer are located between the substrate and the color filter layer, and the color filter layer covers the touch sensing layer and the black matrix layer.

In view of the above, the touch sensing layer and the black matrix layer of the touch display panel described herein are both located on the same substrate, and the boundary of the touch sensing layer is located within the boundary of the black matrix layer. Thereby, the touch display panel has favorable view quality. In addition, the manufacturing method of the touch display panel described herein requires a relatively few number of photomasks for forming the touch display panel, thus reducing the overall manufacturing costs.

### BRIEF DESCRIPTION OF THE DRAWINGS

FIG. 1 is a schematic cross-sectional view illustrating a touch display panel according to an embodiment of the invention.

FIG. 2A to FIG. 2D are schematic flowcharts illustrating a manufacturing process of a touch color filter according to a first embodiment of the invention.

FIG. 3 is a schematic cross-sectional view taken along sectional lines A-A′ and B-B′ in FIG. 2D.

FIG. 4A to FIG. 4C are schematic flowcharts illustrating a manufacturing process of a touch color filter according to a second embodiment of the invention.

FIG. 5 is a schematic cross-sectional view illustrating a touch color filter according to the second embodiment of the invention.

FIG. 6A to FIG. 6C are schematic flowcharts illustrating a manufacturing process of a touch color filter according to a third embodiment of the invention.

FIG. 7 is a schematic cross-sectional view illustrating a touch color filter according to the third embodiment of the invention.

### DETAILED DESCRIPTION OF DISCLOSED EMBODIMENTS

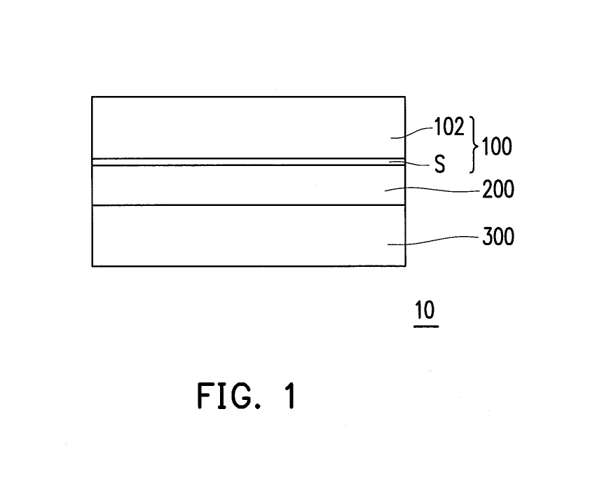

FIG. 1 is a schematic cross-sectional view illustrating a touch display panel according to an embodiment of the invention. With reference to FIG. 1, a touch display panel 10 includes a touch color filter 100, a light modulation layer 200, and an active device array substrate 300. The light modulation layer 200 is located between the touch color filter 100 and the active device array substrate 300. The touch color filter 100 includes a substrate 102 and a touch sensing layer S that is located on the substrate 102. The touch sensing layer S is located between the substrate 102 and the light modulation layer 200. The light modulation layer 200 is able to adjust the light passing through the light modulation layer 200 according to the display requirements. Here, the light modulation layer 200 is, for instance, a liquid crystal layer or an electrophoretic liquid layer, which should not be construed as a limitation to the invention. In other embodiments of the invention, the light modulation layer 200 may also be made of other appropriate materials.

The active device array substrate 300 includes an active device array layer (not shown) located on the substrate 102, and the active device array layer includes a plurality of sub-pixel regions (not shown) defined by a plurality of scan lines and a plurality of data lines. A sub-pixel unit is disposed in anyone of the sub-pixel regions. Each sub-pixel unit is equipped with an active device and a pixel electrode. The design of the active device array layer is well known to people having ordinary skill in the pertinent art and thus will not be further described hereinafter. Those who skilled in the art may modify the design of the active device array according to actual demands. The touch color filter 100 is elaborated hereinafter.

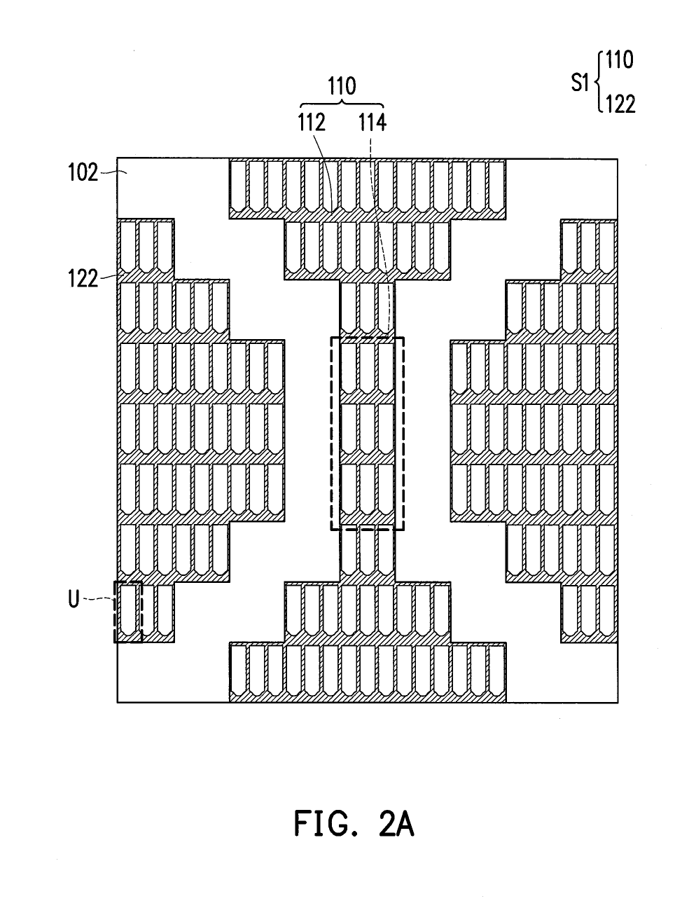

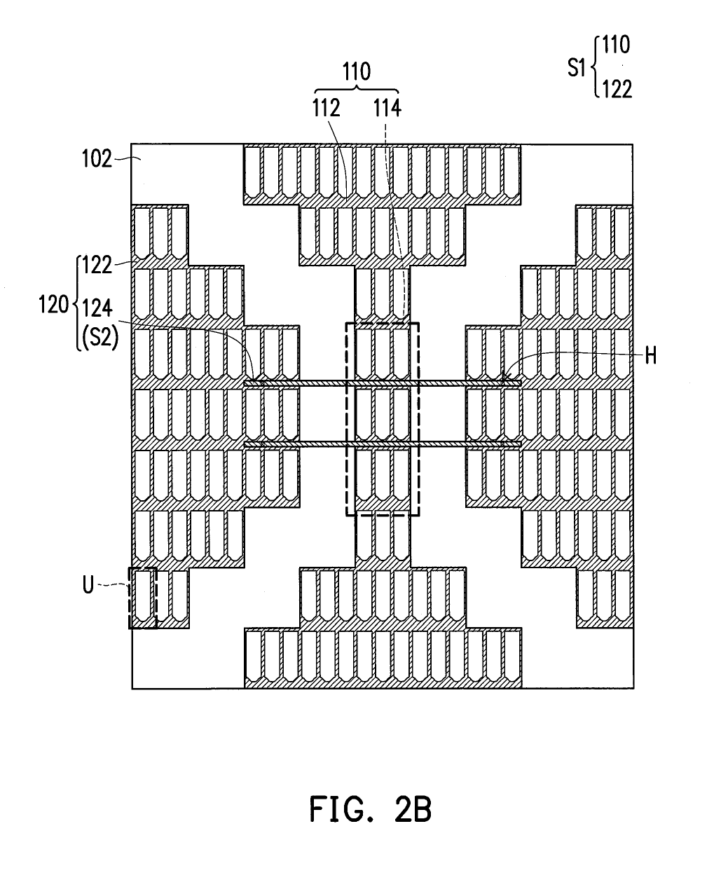

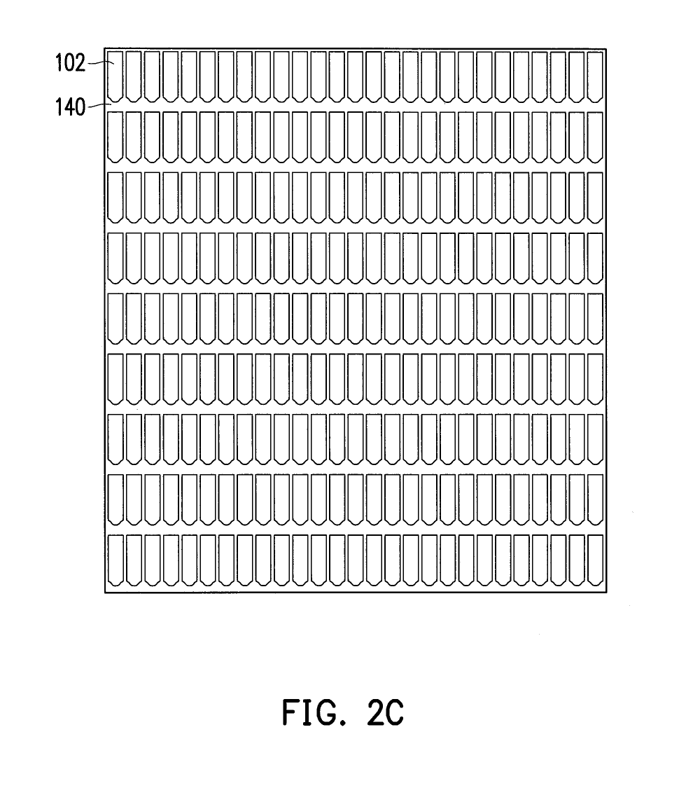

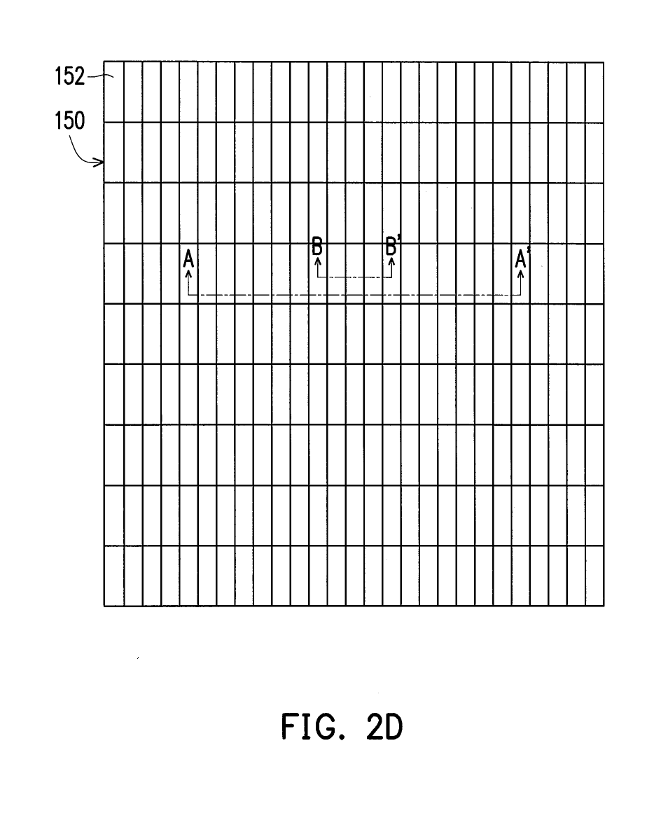

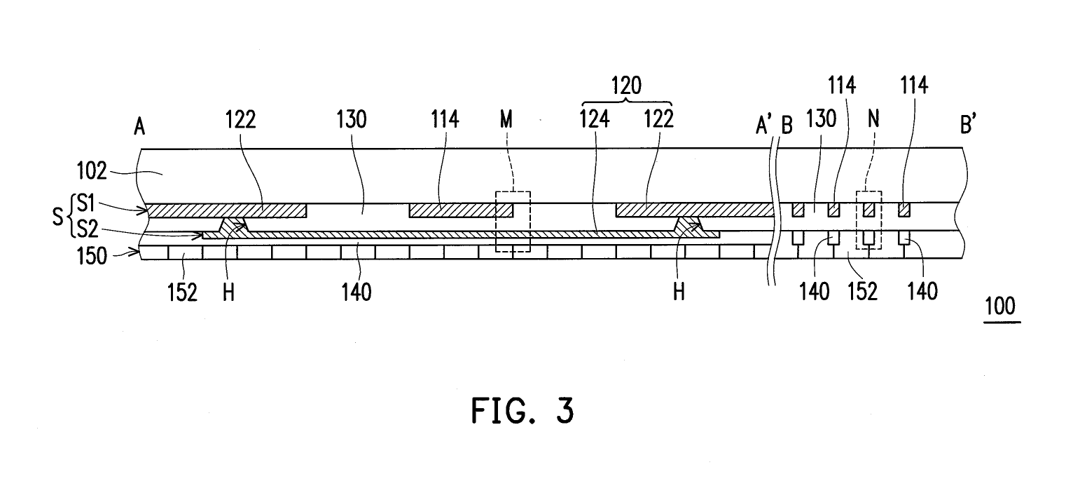

FIG. 2A to FIG. 2D are schematic flowcharts illustrating a manufacturing process of the touch color filter 100 according to a first embodiment of the invention. FIG. 3 is a schematic cross-sectional view illustrating the touch color filter 100 according to the first embodiment of the invention. Specifically, FIG. 3 is a schematic cross-sectional view taken along sectional lines A-A′ and B-B′ in FIG. 2D. With reference to FIG. 2A and FIG. 3, a substrate 102 is provided. A first conductive layer S1 is formed on the substrate 102, and the first conductive layer S1 includes a plurality of first sensing series 110 and a plurality of second sensing pads 122. Each of the first sensing series 110 includes a plurality of first sensing pads 112 and a plurality of first bridge lines 114. Each of the first bridge lines 114 is electrically connected to two adjacent first sensing pads 112. The first sensing series 110 are electrically insulated from one another.

Here, the first conductive layer S1 is made of metal or any other appropriate conductive material, for instance, and the first conductive layer S1 may be a single-layer conductor or a multi-layer conductor. For instance, the first conductive layer S1 is made of the single-layer conductor, such as aluminum (Al), niobium (Nb), etc. The first conductive layer S1 may also be made of the multi-layer conductor, such as molybdenum tantalum/aluminum (MoTa/Al), molybdenum tantalum/niobium (MoTa/Nb), etc.

With reference to FIG. 2B and FIG. 3, an insulation material layer (not shown) is formed, and the insulation material layer is patterned to form an insulation layer 130 with a plurality of openings H. The insulation layer 130 covers the first conductive layer S1. Specifically, the insulation layer 130 covers the substrate 102, the first sensing series 110, and the second sensing pads 122, and the openings H expose the second sensing pads 122. A material of the insulation layer 130 is, for instance, silicon nitride (SiNₓ), silicon oxide (SiOₓ), or any other appropriate insulation material. To clearly illustrate the structure of the first conductive layer S1, the insulation layer 130 is not depicted in FIG. 2B to FIG. 2D.

A second conductive layer S2 is formed on the insulation layer 130. The second conductive layer S2 includes a plurality of second bridge lines 124. Each of the second bridge lines 124 is electrically connected to two adjacent second sensing pads 122 through the openings H, so as to form one of the second sensing series 120. The second sensing series 120 are electrically insulated from one another. Besides, the first sensing series 110 and the second sensing series 120 are electrically insulated. The first conductive layer S1 and the second conductive layer S2 constitute the touch sensing layer S described in the present embodiment. In the present embodiment, it should be mentioned that the first conductive layer S1 includes the first sensing series 110 and the second sensing pads 122, and the second conductive layer S2 includes the second bridge lines 124, for instance. However, the invention is not limited thereto. In another embodiment, the first conductive layer S1 may include the second bridge lines 124, and the second conductive layer S2 may include the first sensing series 110 and the second sensing pads 122. The material of the second conductive layer S2 is the same as that of the first conductive layer S1, for instance.

With reference to FIG. 2C and FIG. 3, a black matrix layer 140 is formed. The black matrix layer 140 has grid-shaped patterns, for instance. The black matrix layer 140 covers the insulation layer 130 and the second conductive layer S2 of the touch sensing layer S. The touch sensing layer S and the black matrix layer 140 are overlapped, and a boundary of the touch sensing layer S is located within a boundary of the black matrix layer 140. According to the present embodiment, the area of the touch sensing layer S on the substrate 102 is smaller than the area of the black matrix layer 140, such that the black matrix layer 140 completely covers the touch sensing layer S in a thickness direction of the touch color filter 100. A profile of the touch sensing layer S is substantially identical to a profile of the black matrix layer 140 in the present embodiment; that is, the shape of the touch sensing layer S is similar to the shape of the black matrix layer 140. Particularly, a portion of the boundary of the touch sensing layer S is located within the boundary of the black matrix layer 140, as shown by a region M in FIG. 3. Besides, a portion of the boundary of the touch sensing layer S may be aligned to the boundary of the black matrix layer 140, as shown by a region N in FIG. 3. Certainly, the invention is not limited thereto, and in other embodiments, a portion of the boundary of the touch sensing layer S in the region N in FIG. 3 may also be located within the boundary of the black matrix layer 140. That is, a portion of the boundary of the touch sensing layer S is spaced from the boundary of the black matrix layer 140 by a distance. In the present embodiment, the black matrix layer 140 is made of non-transparent resin or dark resin, for instance.

With reference to FIG. 2D and FIG. 3, a color filter layer 150 is formed. The color filter layer 150 covers the touch sensing layer S and the black matrix layer 140. The color filter layer 150 includes a plurality of color filter patterns 152. The color filter patterns 152 are, for instance, red, green, or blue color filter patterns. However, the invention is not limited thereto, and people having ordinary skill in the pertinent art may modify the arrangement of the color filter patterns 152 based on actual design demands.

Particularly, the touch color filter 100 described in the present embodiment has both the touch function and the color filter function, and therefore the touch color filter 100, the light modulation layer 200 depicted in FIG. 1, and the active device array substrate 30 depicted in FIG. 1 may be assembled to form the touch display panel 10. In the present embodiment, the black matrix layer 140 is configured to cover the gaps among the color filter patterns 152. Simultaneously, the black matrix layer 140 is configured corresponding to a plurality of sub-pixel units on the active device array substrate 300 depicted in FIG. 1. In particular, the patterns of the black matrix layer 140 correspond to an area where the scan lines and the data lines are distributed on the active device array substrate 300, so as to shield the scan lines and the data lines. Accordingly, the black matrix layer 140 is designed to have the grid-shaped patterns.

In response to the design of the patterns of the black matrix layer 140, the first sensing pads 112, the first bridge lines 114, and the second sensing pads 122 described herein are conductive layers with the grid-shaped patterns. To be specific, the first sensing pads 112, the first bridge lines 114, and the second sensing pads 122 are grid-shaped conductive layers exemplarily constituted by a plurality of grid-shaped units U, as depicted in FIG. 2A or FIG. 2B, and the size of the grid-shaped units U is substantially the same as the size of the sub-pixel units. The design of the grid-shaped patterns of the first sensing pads 112, the first bridge lines 114, and the second sensing pads 122 allows the first sensing pads 112, the first bridge lines 114, and the second sensing pads 122 to be substantially shielded by the black matrix layer 140 without modifying the original pattern design of the black matrix layer 140. Hence, the black matrix layer 140 described herein not only shields the scan lines and the data lines on the active device array substrate 300 but also shields the touch sensing layer S. Thereby, during the usage of the touch color filter described in the present embodiment, the issue of visibility of the patterns of the touch sensing layer S is not apt to occur, and thus the favorable view quality may be achieved.

The structure of the touch color filter described in the following embodiments is similar to that of the touch color filter 100 provided in the first embodiment; therefore, the same or similar components are labeled by the same reference numbers, and the descriptions of the same technical features are omitted hereinafter.

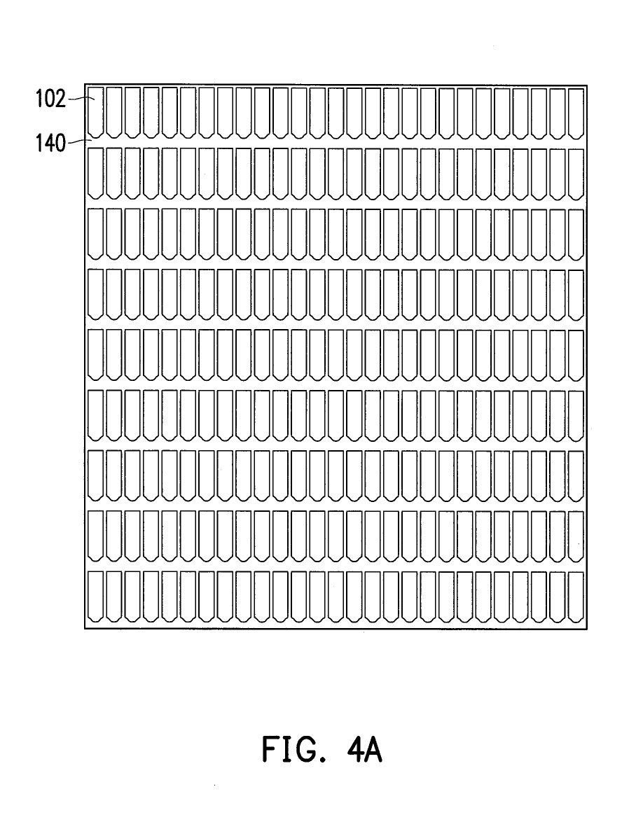

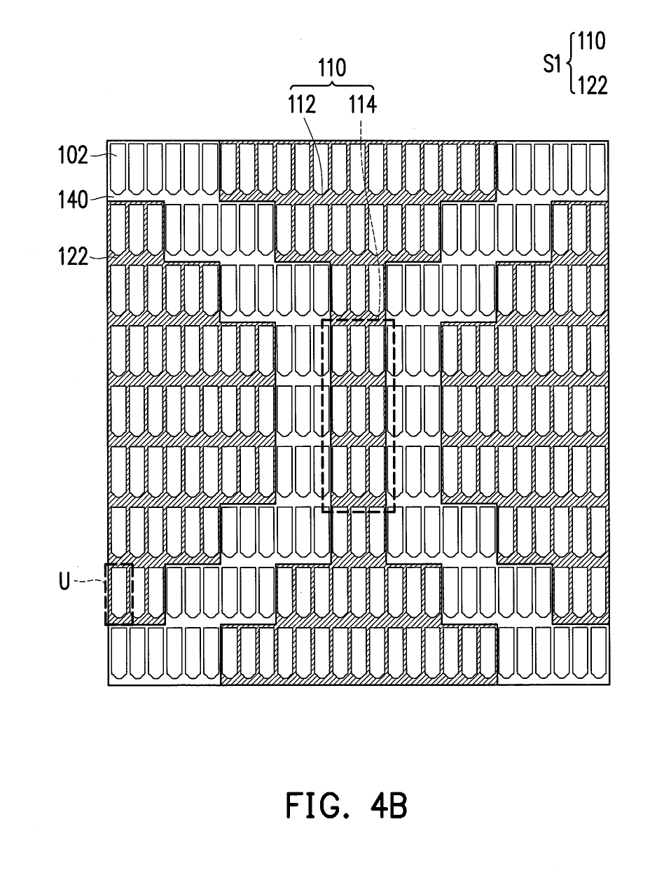

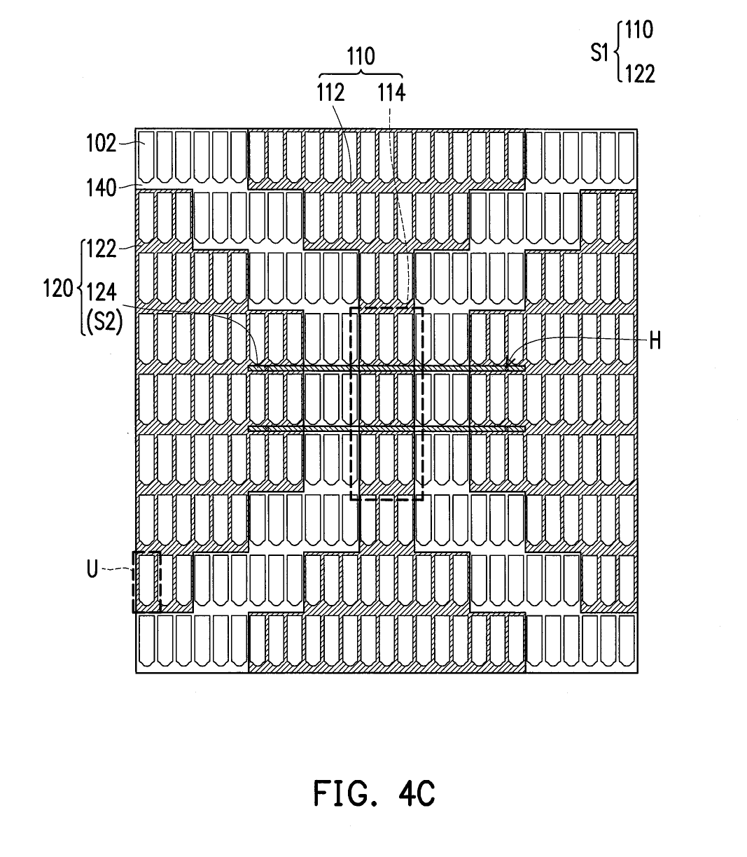

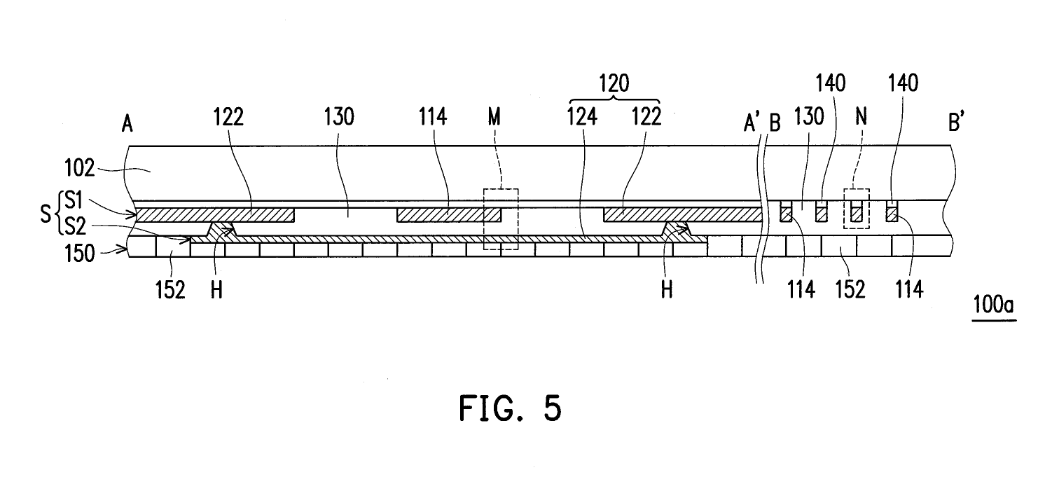

FIG. 4A to FIG. 4C are schematic flowcharts illustrating a manufacturing process of a touch color filter according to a second embodiment of the invention. FIG. 5 is a schematic cross-sectional view illustrating a touch color filter according to the second embodiment of the invention. With reference to FIG. 4A and FIG. 5, the black matrix layer 140 is formed on the substrate 102. The black matrix layer 140 is an insulating light-shielding layer with grid-shaped patterns, for instance. In addition, the black matrix layer 140 described herein is made of non-transparent resin or dark resin, for instance.

With reference to FIG. 4B and FIG. 5, the first conductive layer S1 is formed on the black matrix layer 140. The first conductive layer S1 includes the first sensing series 110 and the second sensing pads 122. The first conductive layer S1 and the black matrix layer 140 are overlapped, and one portion of the boundary of the first conductive layer S1 is located within the boundary of the black matrix layer 140, as shown by the region M. The other portion of the boundary of the first conductive layer 51 may be aligned to the boundary of the black matrix layer 140, as shown by the region N. The insulation layer 130 is then formed. The insulation layer 130 covers the substrate 102, the black matrix layer 140, and the first conductive layer S1, and the insulation layer 130 has a plurality of openings H. To clearly illustrate the structure of the black matrix layer 140 and the structure of the first conductive layer S1, the insulation layer 130 is not depicted in FIG. 4B to FIG. 4C.

With reference to FIG. 4C and FIG. 5, the second conductive layer S2 is formed. The second conductive layer S2 includes a plurality of second bridge lines 124. The second bridge lines 124 and the second sensing pads 122 are serially connected to form the second sensing series 120. The second conductive layer S2 is located on the insulation layer 130 and electrically connected to the first conductive layer S1 through the openings H. Next, the manufacturing process shown in FIG. 2D is performed to form the color filter layer 150, so as to completely form the touch color filter 100a depicted in FIG. 5. The cross-section shown in FIG. 5 may refer to the sectional lines A-A′ and B-B′ depicted in FIG. 2D. The color filter layer 150 covers the second conductive layer S2 and the insulation layer 130. Note that the black matrix layer 140 described herein is located between the substrate 102 and the touch sensing layer S, for instance; hence, when a user observes the touch display panel 10 (depicted in FIG. 1) from the substrate 102 side, the black matrix layer 140 effectively prevents the user from observing the patterns of the touch sensing layer S, so as to improve the view quality of the touch display panel 10.

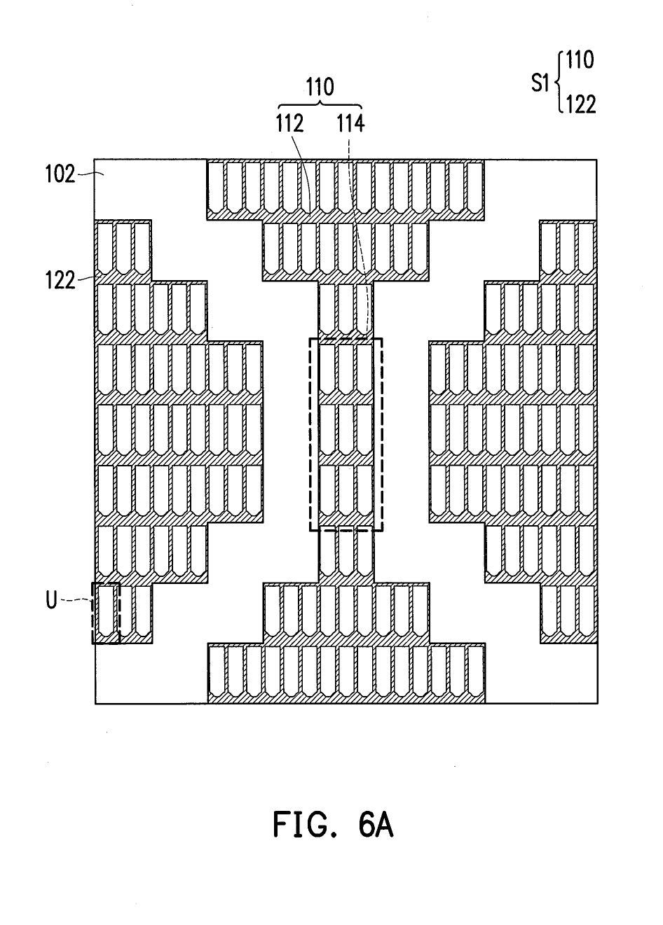

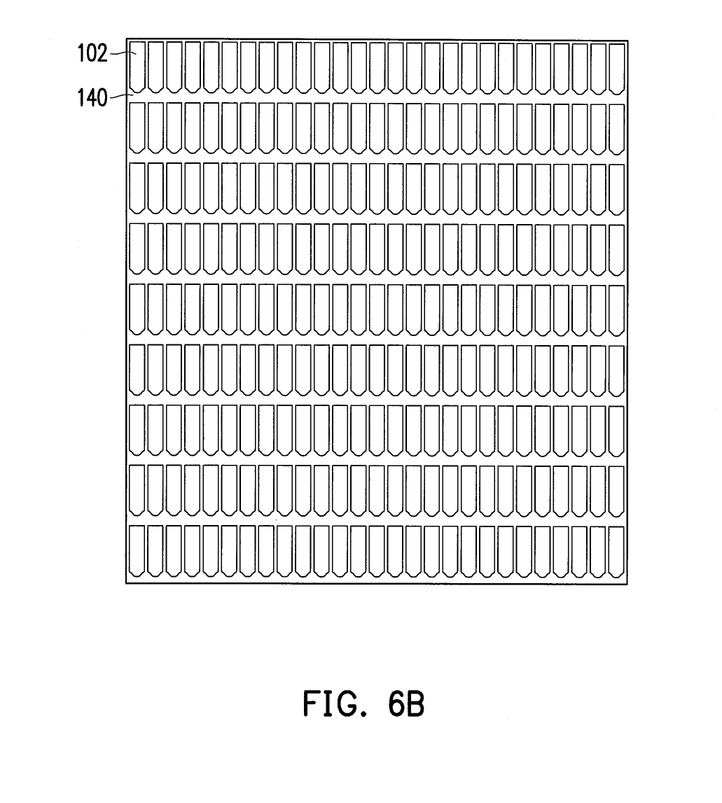

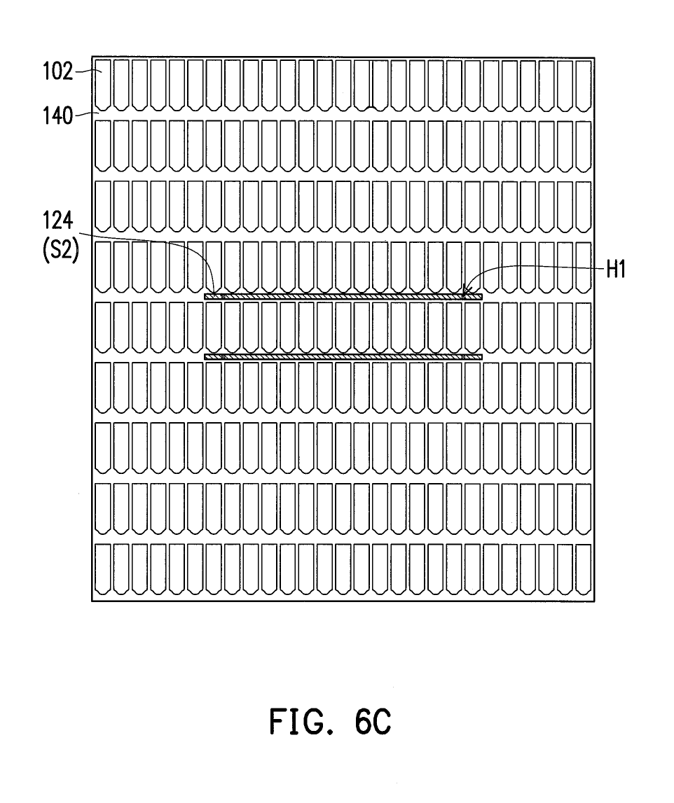

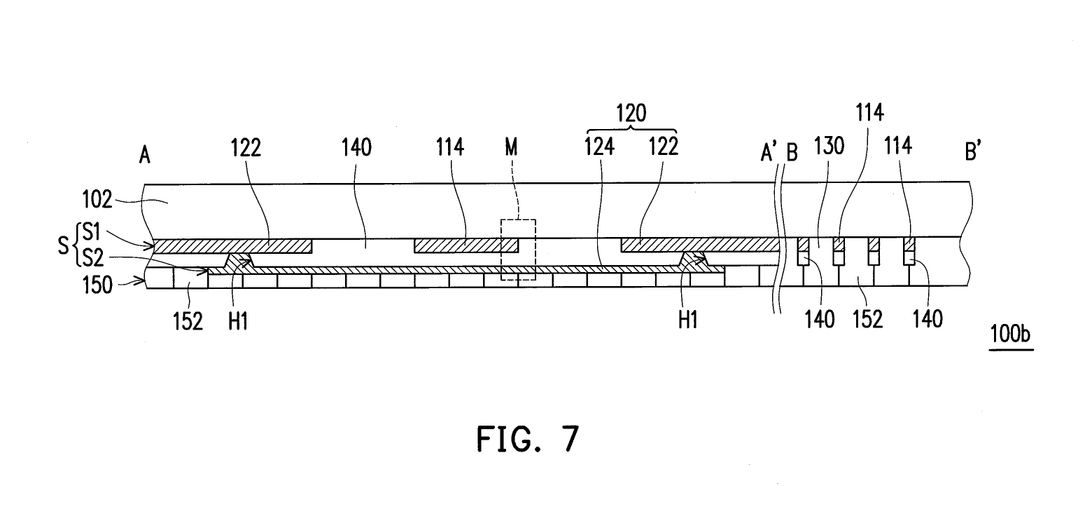

FIG. 6A to FIG. 6C are schematic flowcharts illustrating a manufacturing process of a touch color filter according to a third embodiment of the invention. FIG. 7 is a schematic cross-sectional view illustrating a touch color filter according to the third embodiment of the invention. With reference to FIG. 6A and FIG. 7, the first conductive layer S1 is formed on the substrate 102. The first conductive layer S1 includes the first sensing series 110 and the second sensing pads 122.

With reference to FIG. 6B and FIG. 7, the black matrix layer 140 is formed on the substrate 102. The black matrix layer 140 is an insulating light-shielding layer with grid-shaped patterns, for instance. The first conductive layer S1 and the black matrix layer 140 are overlapped, and the boundary of the first conductive layer S1 is located within the boundary of the black matrix layer 140. The black matrix layer 140 covers the substrate 102 and the first conductive layer S1. Besides, the black matrix layer 140 has a plurality of openings H1.

With reference to FIG. 6C and FIG. 7, the second conductive layer S2 is formed. The second conductive layer S2 includes a plurality of second bridge lines 124. The second bridge lines 124 and the second sensing pad 122 are serially connected to form the second sensing series 120. The second conductive layer S2 is located on the black matrix 140 and electrically connected to the first conductive layer S1 through the openings H1. Next, the manufacturing process shown in FIG. 2D is performed to form the color filter layer 150, so as to completely form the touch color filter 100b depicted in FIG. 7. The cross-section shown in FIG. 7 may refer to the sectional lines A-A′ and B-B′ depicted in FIG. 2D. The color filter layer 150 covers the substrate 102, the second conductive layer S2, and the black matrix layer 140. Note that the black matrix layer 140 described herein is made of dark resin and may provide an insulation function, so as to electrically insulate the first conductive layer S1 from the second conductive layer S2. That is, the black matrix layer 140 in the present embodiment can provide both the shield function and the insulation function, and thus the insulation layer may be omitted. As such, the number of required photomasks may be further reduced, and the manufacturing costs of the touch color filter 100b may be lowered down.

To sum up, the touch sensing layer and the black matrix layer of the touch display panel described herein are both located on the same substrate, and the boundary of the touch sensing layer is located within the boundary of the black matrix layer. Thereby, the touch display panel has favorable view quality. In addition, the manufacturing method of the touch display panel described herein requires a relatively few number of photomasks for forming the touch display panel, thus reducing the overall manufacturing costs.

What is claimed is:

1. A touch color filter comprising:
a substrate;
a touch sensing layer located on the substrate;
a black matrix layer located on the substrate, wherein the touch sensing layer and the black matrix layer are overlapped, and a boundary of the touch sensing layer is located within a boundary of the black matrix layer; and
a color filter layer located on the substrate, wherein the touch sensing layer and the black matrix layer are located between the substrate and the color filter layer, and the color filter layer covers the touch sensing layer and the black matrix layer.

2. The touch color filter as recited in claim 1, wherein a profile of the touch sensing layer is identical to a profile of the black matrix layer.

3. The touch color filter as recited in claim 1, wherein the touch sensing layer comprises:
a first conductive layer comprising a plurality of first sensing series and a plurality of second sensing pads, each of the first sensing series comprising a plurality of first sensing pads and a plurality of first bridge lines, each of the first bridge lines being electrically connected to two of the first sensing pads adjacent to the each of the first bridge lines; and
a second conductive layer comprising a plurality of second bridge lines, the second sensing pads and the second bridge lines being electrically connected to form a plurality of second sensing series, each of the second bridge lines being electrically connected to two of the second sensing pads adjacent to the each of the second bridge lines, wherein the first sensing series and the second sensing series being electrically insulated.

4. The touch color filter as recited in claim 3, further comprising an insulation layer, the first conductive layer being located between the insulation layer and the substrate, the insulation layer covering the first conductive layer and having a plurality of openings, the second conductive layer being located on the insulation layer and electrically connected to the first conductive layer through the openings of the insulation layer, the black matrix layer being located on the insulation layer and covering the second conductive layer.

5. The touch color filter as recited in claim 3, further comprising an insulation layer, the insulation layer having a plurality of openings, the black matrix layer being located between the first conductive layer and the substrate, the insulation layer covering the first conductive layer, the second conductive layer being located on the insulation layer and electrically connected to the first conductive layer through the openings of the insulation layer.

6. The touch color filter as recited in claim 3, wherein the first conductive layer is located between the black matrix layer and the substrate, the black matrix layer covers the first conductive layer and has a plurality of openings, and the second conductive layer is located on the black matrix layer and electrically connected to the first conductive layer through the openings of the black matrix layer.

7. A touch display panel comprising:
a touch color filter comprising:
a substrate;
a touch sensing layer located on the substrate;
a black matrix layer located on the substrate, wherein the touch sensing layer and the black matrix layer are overlapped, and a boundary of the touch sensing layer is located within a boundary of the black matrix layer; and
a color filter layer located on the substrate, wherein the touch sensing layer and the black matrix layer are located between the substrate and the color filter layer, and the color filter layer covers the touch sensing layer and the black matrix layer;
an active device array substrate arranged opposite to the touch color filter; and
a light modulation layer located between the active device array substrate and the touch color filter, the touch sensing layer being located between the substrate and the light modulation layer.

8. A manufacturing method of a touch color filter, comprising following steps:
providing a substrate;
forming a touch sensing layer on the substrate;
forming a black matrix layer on the substrate, wherein the touch sensing layer and the black matrix layer are overlapped, and a boundary of the touch sensing layer is located within a boundary of the black matrix layer; and
forming a color filter layer on the substrate, wherein the touch sensing layer and the black matrix layer are located between the substrate and the color filter layer, and the color filter layer covers the touch sensing layer and the black matrix layer.

9. The method as recited in claim 8, wherein a profile of the touch sensing layer is identical to a profile of the black matrix layer.

10. The method as recited in claim 8, wherein the step of forming the touch sensing layer comprises:
forming a first conductive layer, the first conductive layer comprising a plurality of first sensing series and a plurality of second sensing pads, each of the first sensing series comprising a plurality of first sensing pads and a plurality of first bridge lines, each of the first bridge lines being electrically connected to two of the first sensing pads adjacent to the each of the first bridge lines; and
forming a second conductive layer, the second conductive layer comprising a plurality of second bridge lines, the second sensing pads and the second bridge lines being electrically connected to form a plurality of second sensing series, each of the second bridge lines being electrically connected to two of the second sensing pads adjacent to the each of the second bridge lines, the first sensing series and the second sensing series being electrically insulated.

11. The method as recited in claim 10, wherein the step of forming the touch sensing layer and the black matrix layer comprises:
forming the first conductive layer on the substrate;
forming an insulation layer on the first conductive layer, the insulation layer covering the first conductive layer and having a plurality of openings;
forming a second conductive layer on the insulation layer, the second conductive layer being electrically connected to the first conductive layer through the openings of the insulation layer; and
forming the black matrix layer, the black matrix layer covering the insulation layer and the second conductive layer.

12. The method as recited in claim 10, wherein the step of forming the touch sensing layer and the black matrix layer comprises:
forming the black matrix layer on the substrate;
forming the first conductive layer on the black matrix layer;
forming an insulation layer, the insulation layer covering the first conductive layer and having a plurality of openings; and
forming the second conductive layer on the insulation layer, the second conductive layer being electrically connected to the first conductive layer through the openings of the insulation layer.

13. The method as recited in claim 10, wherein the step of forming the touch sensing layer and the black matrix layer comprises:
forming the first conductive layer on the substrate;
forming the black matrix layer, the black matrix layer covering the first conductive layer and having a plurality of openings;
forming the second conductive layer on the black matrix layer, the second conductive layer being electrically connected to the first conductive layer through the openings of the black matrix layer.
